(19) United States
(12) Patent Application Publication
(10) Pub. No.: US 2010/0119409 A1
(43) Pub. Date: May 13, 2010

(54) Home Biological Defense System

(75) Inventor: Stanley Wiener, Naperville, IL (US)

Correspondence Address: FITCH EVEN TABIN & FLANNERY, 120 SOUTH LASALLE STREET, SUITE 1600, CHICAGO, IL, 60603-3406, US

(73) Assignee: CIVILIAN BIODEFENSE GROUP, Naperville, IL (US)

(21) Appl. No.: 12/684,011

(22) Filed: Jan. 7, 2010

Related U.S. Application Data
(63) Continuation of application No. 11/292,049, filed on Dec. 1, 2005, now abandoned.
(60) Provisional application No. 60/632,314, filed on Dec. 1, 2004.

(51) Int. Cl. A62D 3/00; B01D 46/46; B01D 46/00; A62D 3/30

(52) U.S. Cl. 422/4; 96/397; 422/120; 95/12

(57) ABSTRACT

The invention relates to biological home defense systems for use by populations at risk of widespread biological attack via biological weapons of mass destruction, especially biological weapons involving aerosol attacks. The present invention is also related to methods for using such biological home defense systems wherein meteorological data is used to issue advisories with regard to the use of such biological home defense systems to a population at risk of exposure to biological weapons of mass destruction.

### CROSS-REFERENCE TO RELATED APPLICATION

This application claims the benefit of U.S. Provisional Application No. 60/632,314, filed Dec. 1, 2004, which is incorporated by reference in its entirety herein.

### FIELD OF THE INVENTION

The invention relates to biological home defense systems for use by populations at risk of widespread biological attack via biological weapons of mass destruction, especially biological weapons involving aerosol attacks. The present invention is also related to methods for using such biological home defense systems wherein meteorological data is used to issue advisories with regard to the use of such biological home defense systems to a population at risk of exposure to biological weapons of mass destruction.

### BACKGROUND OF THE INVENTION

The tragic events of Sep. 11, 2001, and the anthrax exposure cases thereafter clearly demonstrated the risks of terrorist attacks on civilian populations anywhere in the world using weapons of mass destruction. Biological weapons pose a significant threat to such civilian populations. Although the anthrax exposure shortly after September 11 appears to be almost exclusively through contact with contaminated mail, these events highlight the potential risk from such biological agents. A likely mode of delivery of highly infectious or toxic agents is by atmospheric release since potentially large populations could be exposed in a relatively short time. Aerosol particles in the range of about 0.3 to about 15 microns in diameter could be delivered by rockets, bomblets with aerosol nozzles, missiles, aircraft equipped with tanks and spray nozzles (e.g., crop dusting aircraft, helicopters, and the like), small boats, trucks, or cars equipped with aerosol generators or from multiple fixed sites in a population-dense area. Delivery to sites 1 to 50 km upwind of large populations centers (e.g., the population corridor extending along the east coast from Washington, D.C., to Boston), could be devastating.

Aerosol or biological agents, when weaponized, may consists of one or more pathogenic species and are usually at much higher concentrations when entering unprotected human airways than when such pathogens are involved in natural epidemics of the diseases they cause. Such attacks are predicted to cause a severe spectrum of diseases with unusually high morality rates. To prevent wide spread casualties from an aerosol attack, it is imperative that access of aerosol particles to the airway and conjunctivae of potential victims be markedly minimized.

Gas-type masks potentially offer at least initial protection from such aerosol bioattacks. To be effective, however, the masks must, in addition to filtering out or otherwise removing the biological agent, should be readily available, inexpensive, easy to use by essentially untrained personnel, present relatively small pressure gradients during breathing, easy to adapt to personnel of varying ages and/or sizes, lightweight, and comfortable to wear for prolonged periods of time (including periods of sleep). We recently described biological defense masks having the desired characteristics for general civilian population use in U.S. patent application Ser. No. 10/316,474, filed on Dec. 12, 2002, which is hereby incorporated by reference.

Bioshield, a $ 5.6 billion program was signed into law on Jul. 21, 2004, by President Bush. This program is designed to help the government buy and deploy defenses against catastrophic attacks with biological agents. The plan is to provide for purchase of smallpox vaccine and a new, anthrax vaccine. Terrorists can defeat this approach this by not using these specific agents. Purchase and stockpiling of antibiotics is also a futile defense since terrorists can use antibiotic resistant agents. In brief a medical treatment defense, when there are high numbers of bioweapon casualties, is at best a salvage operation and not likely to reduce deaths by more than a few percent. The use of rapid responders, stockpiled antibiotics, emergency rooms with added beds and/or isolation rooms, and initiation of vaccinations after a major attack provides only limited protection against massive aerosol release of biological agents of mass destruction. These agents can be easily imported in baggage or large containers into the US and may already be hidden somewhere within our borders. Single cities may be attacked at variable intervals or multiple cities in a period of a few days. The task of immunizing millions of exposed persons, or distributing drugs that may not be effective or cause severe side effects adds to the futility of such an approach. Once there is a mass outbreak of one or more infectious diseases it is certain that the medical system of any large city will be overwhelmed.

Biological defense masks can provide important initial protection for the general population in the event of an attack with weapons of mass destruction. Medical treatment options can provide limited protection for specific biological agents. There remains a need for a longer term, more substantial and more general means of protection for the general population, especially one which can easily and inexpensively incorporated into dwelling units or structures, including existing energy-non-efficient and/or energy-efficient structures as well as new construction. Moreover, there is a need for methods employing such biological defense systems in combination with meteorological data whereby advisories can be issued with regard to the use of such biological defense systems to a population at risk of exposure to biological weapons of mass destruction. The present invention provides such biological defense systems and methods for using them.

### SUMMARY OF THE INVENTION

The invention relates to biological home defense systems for use by populations at risk of widespread biological attack via biological weapons of mass destruction, especially biological weapons involving aerosol attacks. The present invention is also related to methods for using such biological home defense systems wherein meteorological data is used to issue advisories with regard to the beginning and/or termination of use of such biological home defense systems to a population at risk of exposure to biological weapons of mass destruction.

The present invention provides a biological home defense system for use in existing or new construction dwelling structures, said system comprising (1) a variable speed blower motor to draw air into a safe room from an adjacent room through a duct passing though a common wall between the safe room and the adjacent room; (2) at least one filtering element in communication with the blower motor, whereby air from the adjacent room passes through the filtering element and then into the safe room, wherein the filtering element can remove biological agent particles greater than about 0.3 microns in diameter from the air; (3) a pressure sensing device whereby air pressures within the safe room and the adjacent room can be monitored; (4) a carbon dioxide sensing device wherein the carbon dioxide levels in the safe room can be monitored; (5) an exhaust or removal system by which the carbon dioxide level in the safe room can maintained below a preset carbon dioxide value; and (6) a control system; wherein the control system uses air pressure data to control the variable speed blower motor in order to maintain a positive air pressure within the safe room above a preset pressure value; wherein the control system uses the carbon dioxide level data to operate the exhaust or removal system as needed in order to maintain the carbon dioxide level within the safe room below the preset carbon dioxide value; and wherein the safe room is sealed sufficiently to allow the variable speed blower motor to operate at a speed whereby the air passing through the filtering element is efficiently filtered, while maintaining the positive air pressure above the preset pressure value.

This invention also provides a method for protecting a population at risk of exposure to biological weapons of mass destruction containing biological agents, said method comprising:
(1) making biological home defense systems and instructions for their use during a biological warfare attack available to the population;
(2) monitoring for biological warfare attack;
(3) in the event of attack or during periods of high risk of attack, evaluating current and predicted weather patterns in the geographic areas within, adjacent to, and downwind of, the biological warfare attack to determine likely distribution of significant amounts of the biological agents within the geographic areas;
(4) alerting the population and directing the use of the biological home defense systems within the geographic areas of likely distribution of the biological agents;
(5) reevaluating, based on current and predicted weather patterns and data regarding actual distribution of the biological agents within the geographic areas, updated likely distribution of significant amounts of the biological agents within the geographic areas over time to provide updates;
(6) reporting the updates to the population with, as appropriate, instructions for continued use or termination of the use of the biological home defense systems within the geographic areas of updated likely distribution of the biological agents or within new geographic areas of updated likely distribution of the biological agents; and
(7) repeating steps (5) and (6) until no significant risk of exposure remains;
wherein the biological defense systems comprise said system comprising (1) a variable speed blower motor to draw air into a safe room from an adjacent room through a duct passing though a common wall between the safe room and the adjacent room; (2) at least one filtering element in communication with the blower motor, whereby air from the adjacent room passes through the filtering element and then into the safe room, wherein the filtering element can remove biological agent particles greater than about 0.3 microns in diameter from the air; (3) a pressure sensing device whereby air pressures within the safe room and the adjacent room can be monitored; (4) a carbon dioxide sensing device wherein the carbon dioxide levels in the safe room can be monitored; (5) an exhaust or removal system by which the carbon dioxide level in the safe room can maintained below a preset carbon dioxide value; and (6) a control system;
wherein the control system uses air pressure data to control the variable speed blower motor in order to maintain a positive air pressure within the safe room above a preset pressure value; wherein the control system uses the carbon dioxide level data to operate the exhaust or removal system as needed in order to maintain the carbon dioxide level within the safe room below the preset carbon dioxide value; and wherein the safe room is sealed sufficiently to allow the variable speed blower motor to operate at a speed whereby the air passing through the filtering element is efficiently filtered, while maintaining the positive air pressure above the preset pressure value.

Although this invention is mainly intended as a protection measure against biological weapons of mass destruction containing biological agents, it may also be used for other proposes. Thus, for example, the present invention could also to create safe rooms to benefit individuals with severe asthma, severe upper airway allergies, and/or similar debilitating or life threatening respiratory conditions. This invention may also be used to create isolation rooms in the home and/or in non-public or public buildings (e.g., hospitals, nursing homes, and the like); the ability to quickly and inexpensively create such isolation rooms could be especially useful, for example, in case of an influenza pandemic.

### BRIEF DESCRIPTION OF THE DRAWINGS

FIG. 1 illustrates one embodiment of the biological home defense system of this invention used to install a safe room.

FIG. 2A illustrates a flowchart for a controller of the biological home defense system of FIG. 1 under normal operating conditions.

FIG. 2B illustrates a flowchart for a controller of the biological home defense system of FIG. 1 to maintain CO₂ levels in desirable range in the safe room.

### DETAILED DESCRIPTION OF THE PREFERRED EMBODIMENT

The invention relates to biological home defense systems for use by populations at risk of widespread biological attack via biological weapons of mass destruction, especially biological weapons involving aerosol attacks. The present invention is also related to methods for using such biological home defense systems wherein meteorological data is used to issue advisories with regard to the use of such biological home defense systems to a population at risk of exposure to biological weapons of mass destruction.

The present invention uses a relatively small blower motor that draws filtered air into a designated safe room in civilian homes, through appropriate filters, at a rate high enough to maintain a positive air pressure in the room of at least about 0.3 inches water, and preferably about 0.4 to about 0.6 inches water (typically about 100 to about 125 Pascals). Since it is characteristic of civilian rooms, especially older existing structures, to leak air at high rates through porous dry wall and concrete surfaces, visible cracks should be caulked, doors weather stripped, windows covered with polyethylene sheets and duct taped around sheet edges, and all walls, floors, and ceilings painted with a relatively impermeable paint (e.g., epoxy or similar paint products). With most leaks sealed in this manner, motors can be run at low speeds (which allows for efficient operation of filters and lower power consumption) and positive pressure can be maintained easily in the room. Airborne viruses, bacteria, toxins, radioactive particles and war gases cannot enter such a safe room because of the positive pressure and the efficient sealing of all the room surfaces by relatively impermeable paint polymers to even small gas molecules such as nitrogen and oxygen. If these pathogenic agents cannot enter the safe room, they cannot enter the airways of safe room occupants and cause illness and death.

Air from the blower enters a filtering element prior to entering the breathing space within the safe room. The filtering element should effectively remove biological agent particles greater than about 0.3 microns in diameter from the air. Suitable filtering mediums include, for example, high efficiency particulate air (HEPA) filters, ultra-low particle air (ULPA) filters, filters using an electrostatic material such as Advanced Electret Media (AEM; 3M, Minneapolis, Minn.) as described in U.S. Pat. Nos. 5,472,481, 5,350,620, and 5,411,576 (which are hereby incorporated by reference), and the like so long as they exclude particles having a diameter of greater than about 0.3 microns (and more preferably greater than about 0.2 microns) without exhibiting excess pressure gradients during use. Generally, HEPA filters are preferred.

After being filtered, the air passes into the breathing space of the safe room. Air pressure sensors are used to monitor the air pressure inside the safe room and compare it to the pressure outside the safe room to insure a positive pressure above a preset level within the safe room. Data from the air pressure sensor is communicated to a controller which, in turn, can vary the speed of the variable air blower to maintain the desired positive air pressure in the safe room. Generally, a positive air pressure of at least about 0.3 inches water, and preferably about 0.4 to about 0.6 inches water (typically about 100 to about 125 Pascals), is maintained in the room. A carbon dioxide sensor (e.g., an infra red CO₂ sensor) is also connected to the controller to maintain the carbon dioxide levels within the safe room to acceptable levels. When the carbon dioxide in the safe room exceeds a predetermined level (generally a carbon dioxide level of about 0.3 percent), the controller will be activated to lower the carbon dioxide level. For example, the controller could activate a damper in an exhaust port whereby carbon dioxide rich air could be expelled outside the safe room; preferably, the controller would simultaneously speed up the variable speed motor to force the carbon dioxide rich air out more quickly. Once the carbon dioxide level is reduced to an acceptable level within the safe room, the controller would act to close the damper while simultaneously reducing the speed of the variable speed motor to a level to maintain the desired positive pressure within the safe room. Alternatively, a carbon dioxide scrubber system using hydroxides or other absorbents could be used to reduce the carbon dioxide levels; in this case, the control would divert at least a portion of the inside air though the scrubber until acceptable carbon dioxide levels are obtained. Preferably, the carbon dioxide system comprises the exhaust system alone or in combination with the carbon dioxide scrubber.

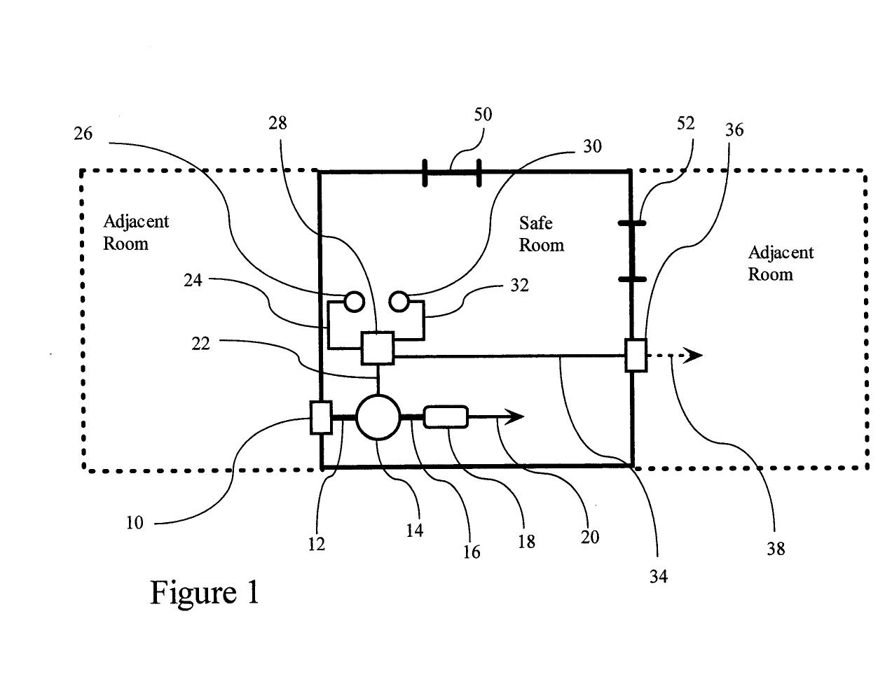

A schematic of the system (not to scale) is shown in FIG. 1. A sealable inlet opening 10 in the wall of the safe room allows air from an adjacent room to be drawn through tubing 12 by variable speed blower 14. The air from the variable speed blower 14 passes through tube 16, through particulate filtering element 18, and into the breathing space in the safe room (indicated by arrow 20). Although not shown in FIG. 1, a optional war or chemical gas filter could be combined with particulate filtering element 18 to provide protection against combined biological and chemical attacks or chemical only attacks. The controller 28, preferably of a programmable type, collects air pressure data from air pressure sensor 26 via line 24 and carbon dioxide data from carbon dioxide sensor 30 via line 32 and uses this data to control the speed of the variable speed blower 14 via line 22 and, thus, the conditions within the safe room.

During normal operation, the controller 28 uses the pressure data from air pressure sensor 26 to maintain a positive air pressure within the safe room of a predetermined level by controlling the speed of the variable speed motor 14. Generally, a positive air pressure of at least about 0.3 inches water, and preferably about 0.4 to about 0.6 inches water (typically about 100 to about 125 Pascals), is maintained in the room. When abnormal carbon dioxide levels are detected via carbon dioxide sensor 30, the controller activates a damper (not shown) in exhaust port 36 whereby carbon dioxide rich air can be expelled outside the safe room (as shown by arrow 38); preferably, the controller would simultaneously speed up the variable speed motor to force the carbon dioxide rich air out more quickly. Once the carbon dioxide sensor 32 detects safe carbon dioxide levels, the controller 28 will shut the exhaust port 36 and return control of the speed of variable speed blower 18 to the air pressure sensor (to maintain a positive air pressure of the desired magnitude in the safe room).

The safe room in FIG. 1 shows a window 50 and a door 52. As noted above, these would normally be sealed to limit air entry around these elements. Normally, plastic film would be used to seal such windows (with duct tape used to seal the edges of the plastic film) and weather stripping used to seal the door. Likewise, caulking can be used to seal visible cracks in walls as well as to seal around electrical outlets, intersections of walls, walls and floor, and walls a ceiling. It has generally been found that such sealing techniques, although helpful, are not sufficient, especially in older homes or apartments, to allow maintenance of the desired positive air pressure without running the variable speed blower at such a high rate that the efficiency of the filtering elements is significantly compromised. Coating all walls, floors, and ceilings with a relatively impermeable paint (e.g., epoxy or similar paint products) in combination with these just mentioned sealing techniques has been found to be effective. With most leaks sealed in this manner, motors can be run at low speeds (which allows for efficient operation of filters and lower power consumption) and positive pressure can be maintained easily in the room.

As noted above, FIG. 1 is not to scale. The actual system can be relatively small in size and can, if desired, be placed in a cabinet or other furniture unit. The holes through the walls to allow air from an adjacent room to be filter and used to provide a positive pressure in the safe room can, of course, be covered by grills or other attractive coverings when not in use. Thus, the room does not need to look like a safe room and can be used for other purposes. Only in the event of an attack would the safe room need to be operated. Because of the small size, relatively small cost, and the ability to use the room for other purposes, the present safe room system can be easily installed in both new-construction or existing homes, apartments, and the like.

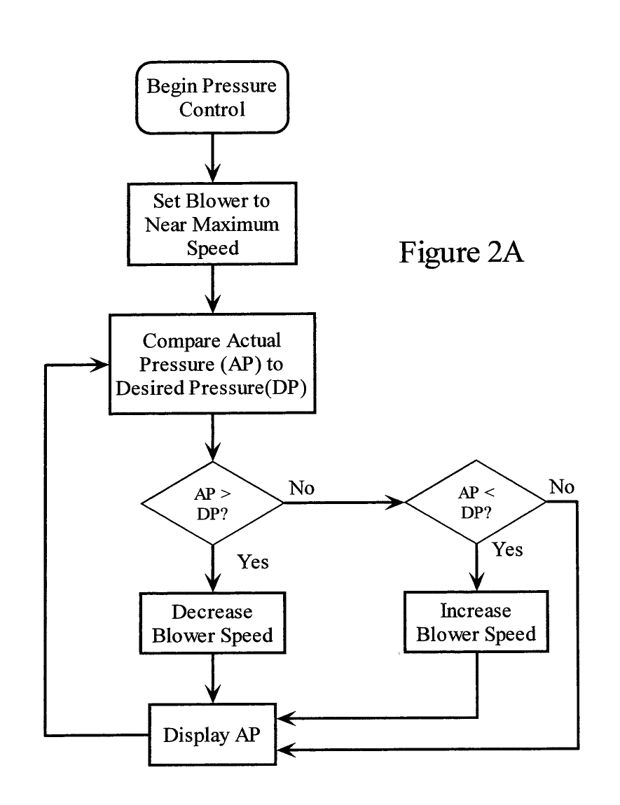

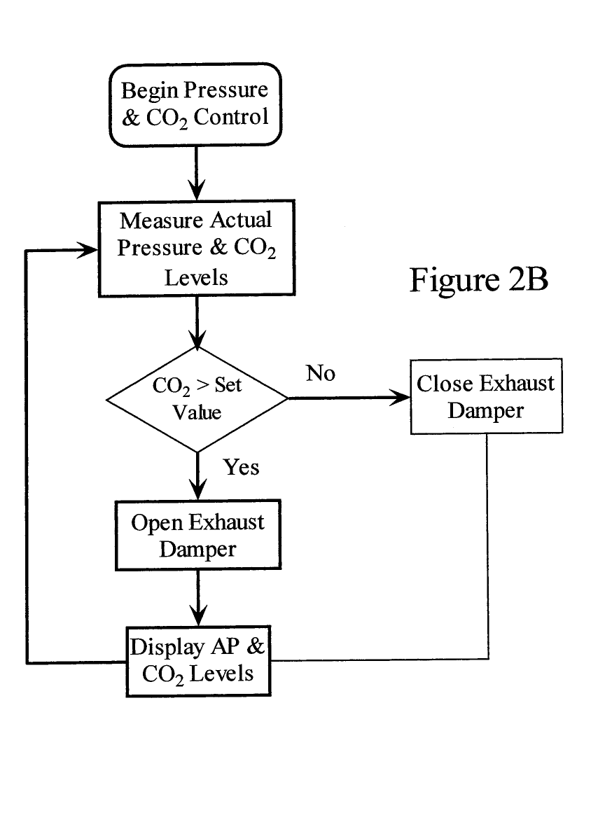

FIG. 2 provides flow charts illustrating controller programs for operating the safe room. FIG. 2A illustrates normal operation whereby the speed of the blower is controlled to obtain the desired positive air pressure in the safe room. FIG. 2B illustrates monitoring and control of the carbon dioxide levels in the safe room. Preferably controller 28 is programmable to allow easy control of the safe room using these, or similar, programming techniques.

Using an approximately 50 to 60 year old civilian, frame construction single family house near the Notre Dame campus, a positive pressure safe room supplied with HEPA and activated carbon (preferably ASZM TEDA carbon filters) filtered air was evaluated. Initially the civilian residential room selected for study leaked air diffusely, not only around portals (door and windows) but diffusely through dry wall surfaces on the floor, ceiling, and walls. Caulking and sealing the door, windows, electric plugs, vents and wall floor seams did not significantly reduce the leaks. The blower motor had to run at 500 cfm or higher to maintain a positive pressure of only 0.1-0.2 inches water. Painting the walls, ceiling, and floor with an epoxy paint (Sherwin Williams EPO paint; approximately 10-17 mils thick) significantly reduced leakage. With the addition of the paint, a positive pressure of about 0.4 to about 0.5 inches water could be easily maintained by operating the blower at only about 70 to about 90 cfm. This positive air pressure is sufficient to prevent particles or gas from entering the room through cracks or through the walls while allowing a sufficiently slow blower speed to operate the filter efficiently. The easily maintained pressure of 0.4-0.5 inches water (100-125 Pascals) has no adverse effects on human beings. A differential pressure monitor that compared safe room pressure to that of the adjacent room was used. The pressure remained constant at about 0.5 inches water for hours and was kept constant by a Nimbus Smart Fan motor controller. Pressure and CO₂ were monitored constantly. The CO₂ level was kept below 0.3 percent. If CO₂ exceeded 0.3 percent, a damper was opened and air allowed to leave the room until the high CO₂ was normalized. The filter element consisted of 31 square feet of pleated HEPA, a 1 inch thick layer of activated carbon, and an electrostatic prefilter. The HEPA filter protect against pathogenic bacteria, toxins, and/or viruses on particles by removing the particles from the air stream. War or chemical gases (as well as CO₂) can be removed by the optional activated carbon filter. Preferably a panel of multiple (e.g., 4 to 6) deep cycle marine batteries can back up the electrical ac motor. This would be used if there were a power outage. For example, using 6 such batteries in a 1400 cubic foot room could provide power for about 15 hours to run the motor.

In addition to sealing obvious leaks around the room (including windows and doors), room preparation should be include painting all wall, floor, and ceiling surfaces with a 10-16 mil layer of suitable epoxy or other suitable paint. This seals out pathogens and markedly slows egress of air from the room allowing the motor to operate under 80-90 cfm. This also reduces battery drain and prolongs the backup power life of the battery pack and allows maintenance of filter efficiency in removing gases and pathogenic particles.

The present biodefense home system of the present invention is especially adapted for use with biomask disclosed in U.S. patent application Ser. No. 10/316,474 and an integrated defense system coordinated by the federal government or other responsible authority. Once a signal of danger is give, the biomask is used to allow individuals to travel to the safe room. The integrated defense system would also provide information during the attack and give the clear signal when it is safe to exit the safe room. The integrated defense system would rely on boundary layer meteorology, air sampling, and testing; to provide the populations of cities and their suburbs with real time signals for use of masks and safe rooms.

In one embodiment, the system uses a Fantech FKD 10×1 blower motor (EBM, Germany), flexible tubing from the wall of an adjacent room to the blower, and HEPA filters downstream from the motor and when needed a 1 inch thick 11 inch long hollow cylinder, internal diameter 8 inches, containing ASZM TEDA carbon. A Nimbus controller attaches to the motor and the keeps room pressure constantly at 0.5 inches water and the CO₂ sensor (Telaire) is attached to a 3″ wall exhaust damper and a recirculation port upstream from the blower motor and opens this as well as the damper when CO₂ exceeds a predetermined value (generally about 0.3 percent) and closes them when it is less than another predetermined value (generally about 0.2 percent). Preferably, operation is automatic once the appropriate parameters are inputted. If desired, displays and alarms can be incorporated into the system to indicate normal and abnormal operation.

In another embodiment, the biological home defense system employs a centrifugal blower (generally about 25 lbs), a flexible, gas/particle impermeable tubing 10″ diameter, 2-4 feet long with an attached metal gasket with rubber or plastic seal at one end that passes through a wall to an adjacent residential room. The non gasket end attaches to the intake port of the centrifugal blower motor and this is held in place by a tightened sealing ring. A hollow plastic or metal cylinder housing of 10″ diameter and height of 24″ is used to contain a 10″ diameter electrostatic filter above which is placed a 10″ diameter HEPA pleated filter (filter area of about 31 ft²). The top 12 inches of the housing has a 1 1/12 inch thick circular layer of TEDA ASZM carbon (internal diameter of about 7-8 inches). The top cap of the upper housing may be removed leaving a clear path for HEPA filtered air to enter the room in the absence of war gases. The motor controller and power cord are attached to the controller or control box of the motor. The motor controller contains a differential pressure sensor; and motor speed is maintained at a flow rate that keeps the room at positive pressure of about 0.4 to about 0.5 inches water. A Nimbus Smart Fan motor controller can be used for this purpose. A CO₂ sensor having a LCD (Telaire or Honeywell) is used to control an exhaust damper and/or a CO₂ scrubber system. These exhaust or removal systems are activated if room CO₂ increases above about 0.3 percent and deactivated as it drops below about 0.2 percent. This prevents CO₂ buildup in the partially sealed room and allows excess CO₂ to escape preventing any even remote risk of asphyxia.

Although not shown in the figures and as indicated in the discussion above, the biological defense systems of this invention may also have an optional chemical filter to provide protection against combined biological and chemical attacks or chemical only attacks. Such optional chemical filters could employ, for example, activated carbon absorbent or other chemical absorbents.

Generally, the filtering element used will not allow particles greater than about 0.3 microns to pass through. Suitable filtering mediums include, for example, HEPA filters, ultra-low particulate air (ULPA) filters, filters using an electrostatic material such as Advanced Electret Media (3M, Minneapolis, Minn.) as described in U.S. Pat. Nos. 5,472,481, 5,350,620, and 5,411,576 (which are hereby incorporated by reference), and the like so long as they exclude particles having a diameter of greater than about 0.3 microns (preferably greater than about 0.2 microns) without exhibiting excess pressure gradients during use. Even more preferably, a HEPA or ULPA filter combined with an electrostatic material filter can be used to provide increased protection.

As noted above, a leaky old room in a private home was converted to into a non-leaky, positive pressure, safe room. We produced the positive pressure room by using potentially contaminated air from an adjacent unsealed room brought in by a Fantech FKD blower motor. This air was filtered through 31 ft2 of HEPA (for bioweapons) and TEDA ASZM carbon filters (for war gases). The filtered air was brought in to the safe room at a rate that exceeded the maximal leak rate of the prepared sealed safe room. This created a positive pressure of 0.4-0.5 inches water (100-125 Pascals); such a pressure made the room impenetrable to bioagents and war gases. Because of room pretreatment to reduce leaks, the blower motor could operate at a very low air flow rate of 70 to 80 cfm. This pretreatment designed for very leaky residential rooms consisted of sealing vents, use of caulking about windows and doors, plugging electrical outlets, covering windows with polyethylene sheets sealed along the edges with duct tape, and painting all six room surfaces with epoxy or other suitable paint. A motor controller was combined with a differential pressure manometer to maintain enough filtered air flow to keep the room at any positive pressure desired. An infra red CO₂ sensor was a safety feature that opened a damper to allow controlled outflow from the room if CO₂ levels rose above 0.3 percent.

The blower would respond temporarily to the open damper by speeding up until the CO₂ level was below 0.2 percent when the damper would close. This safe room system measures positive pressure continuously and uses it to control motor speed to maintain whatever constant positive pressure is desired. This safe room systems measures CO₂ levels and uses this measurement to open a damper to exhaust CO₂ air. It could also control a recirculation pathway that is connected to the air flow system, upstream from the motor, which uses calcium hydroxide to CO₂.

The biological warfare masks of our previous invention and the safe rooms provided by the present invention are ideally suited for use in a general method for protecting civilian populations. Moreover, the biological warfare systems of this invention are ideally suited for use in a method for protecting a population at risk of exposure to biological weapons of mass destruction containing biological agents, said method comprising: (1) making biological defense systems and instructions for their use during a biological warfare attack available to the population; (2) monitoring for biological warfare attack; (3) in the event of attack or during periods of high potential of attack, evaluating current and predicted weather patterns in the geographic areas within, adjacent to, and downwind of, the biological warfare attack to determine likely distribution of significant amounts of the biological agents within the geographic areas; (4) alerting the population and directing the use of the biological defense systems within the geographic areas of likely distribution of the biological agents; (5) reevaluating, based on current and predicted weather patterns and data regarding actual distribution of the biological agents within the geographic areas, updated likely distribution of significant amounts of the biological agents within the geographic areas over time to provide updates; (6) reporting the updates to the population with, as appropriate, instructions for continued use or termination of the use of the biological defense systems within the geographic areas of updated likely distribution of the biological agents or within new geographic areas of updated likely distribution of the biological agents; and (7) repeating steps (5) and (6) until no significant risk of exposure remains.

This biological defense system is designed to be available to an at-risk population. Although any population may be considered at-risk of a terrorist attack, large population centers (i.e., major cities) are more likely to be targeted. The systems may be distributed by local, state, or national governments or may be made available to the general public through retail outlets. The method also involves monitoring (preferably continuous monitoring) for such biological warfare attack. Once such an attack is detected or if the risk of such attack is high, weather conditions and patterns in the vicinity of the target area are to be evaluated in order to determine the likely geographic distribution of biological agents from such an attack and the areas of potentially significant exposure. Especially important weather conditions to be considered are temperature inversions and wind conditions (especially conditions involving low or no winds). Temperature inversions and low ground wind speeds will tend to keep the biological agent cloud intact, close to the ground, and delay its dispersion, thereby increasing the risk of exposure to the population in the area. On the other hand, high wind speed and the absence of temperature inversions will tend to disperse the biological agent cloud and reduce the risk of significant exposure.

Once the areas of potentially significant exposure have been determined, instructions and warnings to the affected population should be issued. Such instructions, which can be issued through local TV and radio outlets, local emergency broadcast or other warning systems, National Oceanic and Atmospheric Administration (NOAA) weather radio, should include directions on when and how to use biological defense masks and the biological home defense systems as well as other information (e.g., protect food and water supplies from contact with outside air, and the like). Evaluation should continue to provide updated assessments for the areas at risk in the initial attack as well as to issue new warnings to other areas that may be later threatened by the attack (or other attacks that may follow). The continued evaluation can also incorporate data from measurements of actual exposure to the biological warfare agent (in addition to data regarding actual and expected weather conditions). Actual exposure data could be generated, for example, using specific biochemical or biological tests (e.g., PCR and the like). Generally, safe room usage should continue until an “all-clear” message is issued. Such an “all-clear” message can generally be issued about 1 to 2 hours after the temperature inversion has lifted, the wind speed increased significantly, or actual biochemical exposure data indicates the threat has passed.

As noted above, the present invention can also be used to create safe rooms to benefit individuals with severe asthma, severe upper airway allergies, and/or similar debilitating or life threatening respiratory conditions. This invention may also be used to create isolation rooms in the home and/or in non-public or public buildings (e.g., hospitals, nursing homes, and the like); the ability to quickly and inexpensively create such isolation rooms could be especially useful, for example, in case of an influenza pandemic.

For a safe room designed for respiratory or similar conditions, air entering the room can be limited to air from outside the dwelling or an adjacent room that is blown into the room by the motor and passes through the filter-containing housing to enter the room; preferably a HEPA filter is used. In such applications, a chemical filter will typically not be needed; typically, the CO₂ indicator or the wall damper for removal of CO₂ will not be required in this modification. Moreover, sealing room surfaces will not be needed unless wall penetration by allergens is a problem. If the room surfaces are sealed, then the CO₂ indicator and the wall damper to control CO₂ levels should be used.

A modification of the above described hardware can be used to create an isolation room for family members who are ill with pandemic influenza (such as avian H5N1) or highly contagious diseases treated in the home to protect well family members and visiting friends. The chemical filter will typically be unnecessary and can be removed. A flexible air-impermeable duct can connected to the open end of the filter (preferably HEPA) housing. This duct will be connected distally to an outside adjacent wall or window gasket so that air will be blown through the motor from the sick room, through the filter, and then vented to the exterior of the home to avoid contaminating the outside environment. The motor controller should maintain a slight negative room pressure (typically about 0.2 to about 0.3 inches water gauge (Wg)) relative to other rooms in the house and the outside air. In the event of pandemic avian influenza there may be thousands of ill persons that will be turned away from hospitals with limited numbers of isolation rooms (typically 3-4 per hospital). In the home, use of HEPA nose mouth covering disposable masks can be used to protect the well persons who enter the room. Additionally disposable gowns and gloves can also be used by those nursing the ill patient(s). Such simple technology should prevent viral contamination of the entire home and should result in reduction of family morbidity and mortality. This hardware can also be used by hospitals to rapidly and inexpensively increase their numbers of isolation rooms. Sealing of walls might be required in some leaky isolation rooms with porous dry wall or concrete plaster surfaces to allow attainment of negative isolation room pressures.

What is claimed is:

1. A biological home defense system for use in existing or new construction dwelling structures, said system comprising:
(1) a variable speed blower motor to draw air into a safe room from an adjacent room through a duct passing though a common wall between the safe room and the adjacent room;
(2) at least one filtering element in communication with the blower motor, whereby air from the adjacent room passes through the filtering element and then into the safe room, wherein the filtering element can remove biological agent particles greater than about 0.3 microns in diameter from the air;
(3) a pressure sensing device whereby air pressures within the safe room and the adjacent room can be monitored;
(4) a carbon dioxide sensing device wherein the carbon dioxide levels in the safe room can be monitored; and
(5) an exhaust or removal system by which the carbon dioxide level in the safe room can maintained below a preset carbon dioxide value; and (6) a control system;
wherein the control system uses air pressure data to control the variable speed blower motor in order to maintain a positive air pressure within the safe room above a preset pressure value; wherein the control system uses the carbon dioxide level data to operate the exhaust or removal system as needed in order to maintain the carbon dioxide level within the safe room below the preset carbon dioxide value; and wherein the safe room is sealed sufficiently to allow the variable speed blower motor to operate at a speed whereby the air passing through the filtering element is efficiently filtered, while maintaining the positive air pressure above the preset pressure value.

2. The biological home defense system as defined in claim 1, wherein the safe room is sealed using an epoxy paint to coat the walls, ceiling, and floor of the safe room.

3. The biological home defense system as defined in claim 1, wherein the filtering element is a HEPA filter, a filter containing an electrostatic material, or a combination HEPA and electrostatic material filter.

4. The biological home defense system as defined in claim 2, wherein the filtering element is a HEPA filter, a filter containing an electrostatic material, or a combination HEPA and electrostatic material filter.

5. The biological home defense system as defined in claim 3, further comprising a chemical filter through which air can pass to provide further protection in the case of a chemical attack.

6. The biological home defense system as defined in claim 4, further comprising a chemical filter through which air can pass to provide further protection in the case of a chemical attack.

7. A method for protecting a population at risk of exposure to biological weapons of mass destruction containing biological agents, said method comprising:
(1) making biological home defense systems and instructions for their use during a biological warfare attack available to the population;
(2) monitoring for biological warfare attack;
(3) in the event of attack or during periods of high risk of attack, evaluating current and predicted weather patterns in the geographic areas within, adjacent to, and downwind of, the biological warfare attack to determine likely distribution of significant amounts of the biological agents within the geographic areas;
(4) alerting the population and directing the use of the biological home defense systems within the geographic areas of likely distribution of the biological agents;
(5) reevaluating, based on current and predicted weather patterns and data regarding actual distribution of the biological agents within the geographic areas, updated likely distribution of significant amounts of the biological agents within the geographic areas over time to provide updates;
(6) reporting the updates to the population with, as appropriate, instructions for continued use or termination of the use of the biological home defense systems within the geographic areas of updated likely distribution of the biological agents or within new geographic areas of updated likely distribution of the biological agents; and
(7) repeating steps (5) and (6) until no significant risk of exposure remains;
wherein the biological home defense systems comprise (1) a variable speed blower motor to draw air into a safe room from an adjacent room through a duct passing though a common wall between the safe room and the adjacent room; (2) at least one filtering element in communication with the blower motor, whereby air from the adjacent room passes through the filtering element and then into the safe room, wherein the filtering element can remove biological agent particles greater than about 0.3 microns in diameter from the air; (3) a pressure sensing device whereby air pressures within the safe room and the adjacent room can be monitored; (4) a carbon dioxide sensing device wherein the carbon dioxide levels in the safe room can be monitored; (5) an exhaust or removal system by which the carbon dioxide level in the safe room can maintained below a preset carbon dioxide value; and (6) a control system;
wherein the control system uses air pressure data to control the variable speed blower motor in order to maintain a positive air pressure within the safe room above a preset pressure value; wherein the control system uses the carbon dioxide level data to operate the exhaust or removal system as needed in order to maintain the carbon dioxide level within the safe room below the preset carbon dioxide value; and wherein the safe room is sealed sufficiently to allow the variable speed blower motor to operate at a speed whereby the air passing through the filtering element is efficiently filtered, while maintaining the positive air pressure above the preset pressure value.

8. The method as defined in claim 7, wherein the safe room is sealed using an epoxy paint to coat the walls, ceiling, and floor of the safe room.

9. The method as defined in claim 7, wherein the filtering element is a HEPA filter, a filter containing an electrostatic material, or a combination HEPA and electrostatic material filter.

10. The method as defined in claim 8 wherein the filtering element is a HEPA filter, a filter containing an electrostatic material, or a combination HEPA and electrostatic material filter.

11. The method as defined in claim 9, wherein the biological home defense systems further comprise a chemical filter through which air can pass to provide further protection in the case of a chemical attack.

12. The method as defined in claim 10, wherein the biological home defense systems further comprise a chemical filter through which air can pass to provide further protection in the case of a chemical attack.

13. A safe room system for use in existing or new construction structures for individuals with severe respiratory conditions, said system comprising:
(1) a variable speed blower motor to draw air into a safe room from an adjacent room through a duct passing though a common wall between the safe room and the adjacent room;
(2) at least one filtering element in communication with the blower motor, whereby air from the adjacent room passes through the filtering element and then into the safe room, wherein the filtering element can remove biological agent particles greater than about 0.3 microns in diameter from the air;
(3) a pressure sensing device whereby air pressures within the safe room and the adjacent room can be monitored; and
(4) a control system;
wherein the control system uses air pressure data to control the variable speed blower motor in order to maintain a positive air pressure within the safe room above a preset pressure value; and wherein the safe room is sealed sufficiently to allow the variable speed blower motor to operate at a speed whereby the air passing through the filtering element is efficiently filtered, while maintaining the positive air pressure above the preset pressure value.

14. An isolation room system for use in existing or new construction structures, said system comprising:
(1) a variable speed blower motor to draw air from an isolation room and vent it outside the structure via a duct passing though a common wall between the isolation room and the outside;
(2) at least one filtering element in communication with the blower motor, whereby air from the isolation room passes through the filtering element and then to the outside, wherein the filtering element can remove biological agent particles greater than about 0.3 microns in diameter from the air; and
(3) a pressure sensing device whereby air pressures within the isolation room and the outside and other rooms in the structure can be monitored; and (4) a control system;
wherein the control system uses air pressure data to control the variable speed blower motor in order to maintain a negative air pressure within the isolation room relative to outside and other rooms in the structure at a preset pressure value; and wherein the safe room is sealed sufficiently to allow the variable speed blower motor to operate at a speed whereby the air passing through the filtering element is efficiently filtered, while maintaining the negative air pressure at the preset pressure value.
